(19) United States
(12) Patent Application Publication
(10) Pub. No.: US 2023/0352962 A1
(43) Pub. Date: Nov. 2, 2023

(54) HYBRID HEAVY LIFT DRONE

(71) Applicant: Big Bee Corp, West Palm Beach, FL (US)

(72) Inventors: Nestor Adrian Velez Cano, West Palm Beach, FL (US); Deivin Steven Castaño Luna, West Palm Beach, FL (US)

(21) Appl. No.: 17/661,021

(22) Filed: Apr. 27, 2022

(51) Int. Cl. H02J 7/14; H02K 7/18; H02J 7/02; B64C 39/02; B64D 27/24; B64D 27/10

(52) U.S. Cl. CPC H02J 7/1423; H02K 7/1807; H02J 7/02; B64C 39/024; B64D 27/24; B64D 27/10; H02J 7/345

(57) ABSTRACT

A drone, including one or more propellers configured to lift the drone, a heat engine configured to generate mechanical movement, an electric generator configured to receive the mechanical movement and generate electric power, and a plurality of graphene supercapacitor banks configured to receive the electric power generated by the electric generator. Each of the graphene supercapacitor banks includes graphene supercapacitors arranged in series. The graphene supercapacitor banks are configured to provide power to the propellers.

### BACKGROUND

### Technological Field

The present disclosure relates to power systems, in particular to hybrid power systems of uncrewed aerial vehicles, herein referred to as “UAVs” or “drones.”

### Description of the Related Technology

The use of drones is fast becoming ubiquitous, and the business sector is discovering an increasing number of applications for the technology. Drones are often battery powered, and most have a relatively short flight time due to high energy consumption and the weight of the batteries needed to operate them. While drones may be controlled semi-autonomously or, even, fully-autonomously, what a drone can accomplish without human intervention is limited due to the relatively short flight time. Using current power systems, frequent returns to a base station to charge or swap out battery packs may be required, thereby limiting the drone's effective range and capabilities.

### SUMMARY OF CERTAIN INVENTIVE ASPECTS

The systems, methods, and devices of this disclosure each have several innovative aspects, no single one of which is solely responsible for all the desirable attributes disclosed herein.

An aspect is directed to embodiments of a drone including one or more propellers configured to lift the drone, a heat engine configured to generate mechanical movement, an electric generator configured to receive the mechanical movement and generate electric power, and one or more graphene supercapacitor banks configured to receive the electric power generated by the electric generator. Each of the one or more graphene supercapacitor banks includes a plurality of graphene supercapacitors coupled in series. The one or more graphene supercapacitor banks can be configured to provide power to the one or more propellers.

A variation of the aspect above further includes a 3-phase ideal diode bridge rectifier. The 3-phase ideal diode bridge rectifier can be configured to rectify an alternating current received from the electric generator into a direct current provided to the one or more graphene supercapacitor banks.

A variation of the aspect above is, wherein the one or more graphene supercapacitor banks are connected in series to the 3-phase ideal diode bridge rectifier, forming a charging state.

A variation of the aspect above further includes a battery bank configured to power the one or more propellers and one or more transistors configured to selectively connect the one or more graphene supercapacitor banks in parallel to provide power to the one or more propellers in a discharge state.

A variation of the aspect above further includes one or more transistors configured to alternately connect the one or more graphene supercapacitor banks in series and in parallel and a controller configured to control the one or more transistors.

A variation of the aspect above is, wherein the one or more transistors comprise one or more insulated gate bipolar transistors.

A variation of the aspect above is, wherein each of the plurality of graphene supercapacitors has a voltage of about 2.7 V and a capacitance of 1 F to 5000 F.

An aspect is directed to embodiments of a hybrid power system including a source of mechanical movement, an electric generator configured to receive mechanical movement from the source of mechanical movement and generate electric power, a rectifier, one or more graphene supercapacitor banks configured to receive the electric power generated by the electric generator. Each of the one or more graphene supercapacitor banks can include a plurality of graphene supercapacitors coupled in series. The hydrid power system can further include a battery bank, a charging circuit comprising the rectifier and the one or more graphene supercapacitor banks, and a discharge circuit comprising the battery bank and the one or more graphene supercapacitor banks.

A variation of the aspect above is, wherein the source of mechanical movement is an internal combustion engine.

A variation of the aspect above is, wherein the internal combustion engine is a hydrogen engine.

A variation of the aspect above is, wherein the source of mechanical movement is a wind turbine or a hydraulic turbine.

A variation of the aspect above is, wherein the electric generator is a permanent magnet brushless motor, an internal permanent magnet motor, a three phase AC induction copper rotor motor, a permanent magnet brushless axial flux motor, a synchronous reluctance generator, or an alternator.

A variation of the aspect above is, wherein the rectifier is a 3-phase ideal diode bridge rectifier.

A variation of the aspect above further includes one or more transistors configured to alternately connect the one or more graphene supercapacitor banks to the charging circuit and to the discharge circuit and a controller configured to control the one or more transistors.

A variation of the aspect above is, wherein the charging circuit is a series circuit, and the discharge circuit is a parallel circuit.

A variation of the aspect above is, wherein the controller is a field programmable gate array.

An aspect is directed to embodiments of a graphene supercapacitor bank system that includes one or more graphene supercapacitors banks configured to receive a direct current supply. Each of the one or more graphene supercapacitor banks can include a plurality of graphene supercapacitors coupled in series. The system can further include a battery bank and a plurality of transistors controlled by a controller. The one or more graphene supercapacitor banks can be coupled in a series circuit with the direct current supply by the plurality of transistors. The one or more graphene supercapacitor banks can be coupled in a parallel circuit with the battery bank by the plurality of transistors.

A variation of the aspect above is, wherein the plurality of graphene supercapacitors have a capacitance of at least 1 F and at most 5000 F.

A variation of the aspect above is, wherein the plurality of graphene supercapacitors have a voltage of 2.7V.

A variation of the aspect above is, wherein the controller is configured to alternatively place the one or more graphene supercapacitor banks in the series circuit and in the parallel circuit.

A variation of the aspect above is, wherein the controller is a field programmable gate array.

### BRIEF DESCRIPTION OF THE DRAWINGS

Throughout the drawings, reference numbers can be reused to indicate general correspondence between reference elements. The drawings are provided to illustrate example embodiments described herein and are not intended to limit the scope of the disclosure.

FIG. 1A shows a front view of an example of a drone, in accordance with certain embodiments.

FIG. 1B shows a side view of an example of a drone, in accordance with certain embodiments.

FIG. 1C shows a top view of an example of a drone, in accordance with certain embodiments.

FIG. 1D illustrates a block diagram of an example of a drone, in accordance with certain embodiments.

FIG. 2A illustrates a circuit diagram of a hybrid power system including a graphene super capacitor bank, in accordance with certain embodiments.

FIG. 2B illustrates a circuit diagram of a charging state of a hybrid power system including a graphene super capacitor bank, in accordance with certain embodiments.

FIG. 2C illustrates a circuit diagram of a discharging state of a hybrid power system including a graphene super capacitor bank, in accordance with certain embodiments.

### DETAILED DESCRIPTION

Uncrewed aerial vehicles (UAVs), often referred to as “drones,” are increasingly being used to offset the need for human labor. This is particularly the case in areas where there is a labor shortage or an inherent risk to human life. For example, drones may be used to advantage in the agriculture industry, where sudden labor shortages may interfere with delicate crop timetables for planting, watering, harvesting, etc.

Drones are often battery-powered, and most have a relatively short flight time due to high energy consumption and the weight of the batteries needed to operate them. While drones may be controlled semi-autonomously, or even autonomously, what a drone can accomplish without human intervention is limited due to the relatively short flight time. For example, a drone used in the agriculture industry may be configured to autonomously survey crop fields, but it may require frequent returns to a base station in order to charge or swap out battery packs. This may limit its effective range and the effectiveness of its crop surveying capabilities. Thus, there is a need for a power system that can increase a drone's flight time. One solution, as disclosed herein, is a drone equipped with a hybrid power system.

The hybrid power system described herein may provide a drone with a supplemental power source, thereby extending its flight time. With a longer flight time, the drone may achieve a higher degree of efficiency autonomy. Furthermore, while the battery packs required to operate many drones have special charging requirements, a hybrid power system may be configured to be powered primarily by a heat engine (e.g., an internal combustion engine) that can be refueled at a typical gas station. At the same time, by using a hybrid power system, the energy collected from the heat engine is more efficient, thereby resulting in lower polluting gas emissions over time.

It should be appreciated that the hybrid power system disclosed herein may be implemented in situations other than drone operation. For example, the hybrid power system may also be advantageously implemented to supplement the power output of a power station such as a wind turbine or hydraulic turbine.

### Drone

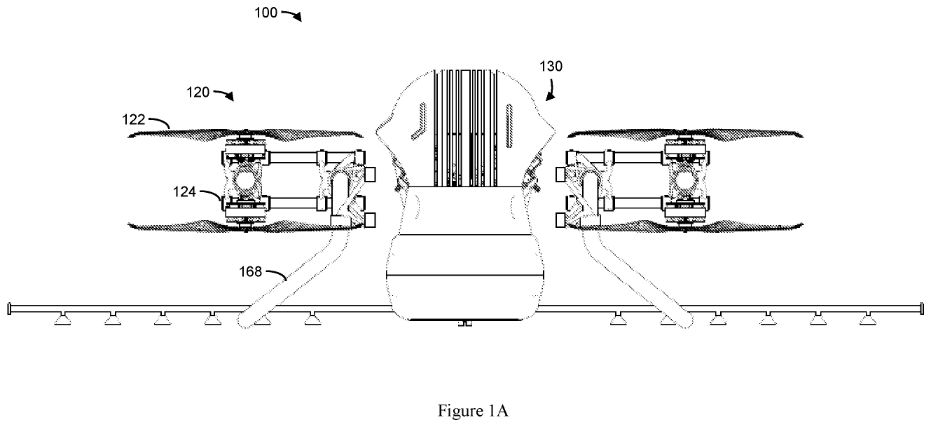

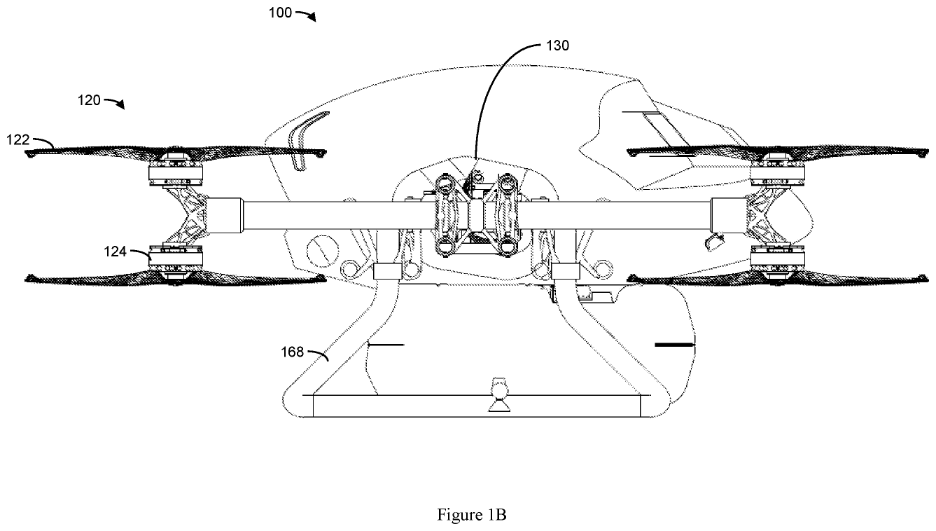

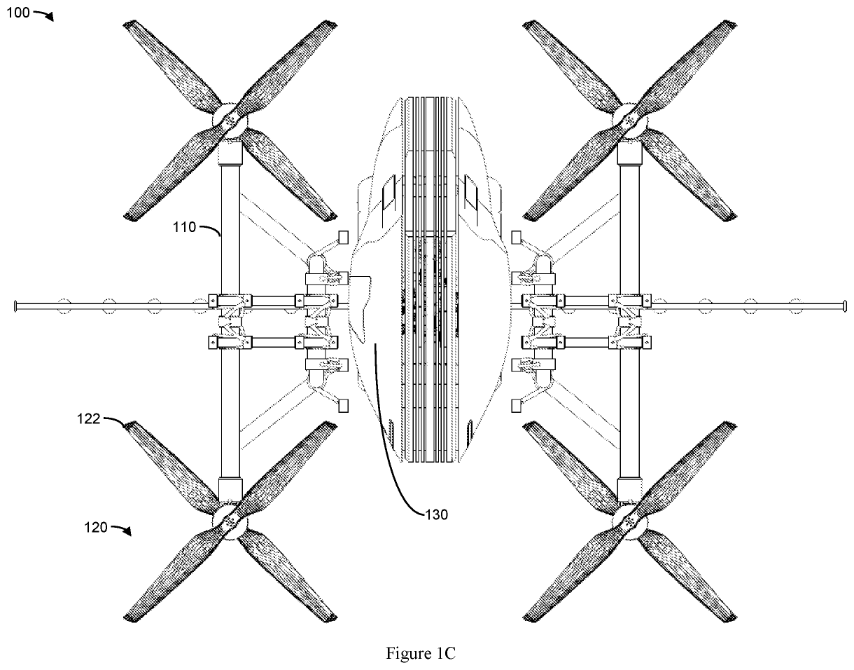

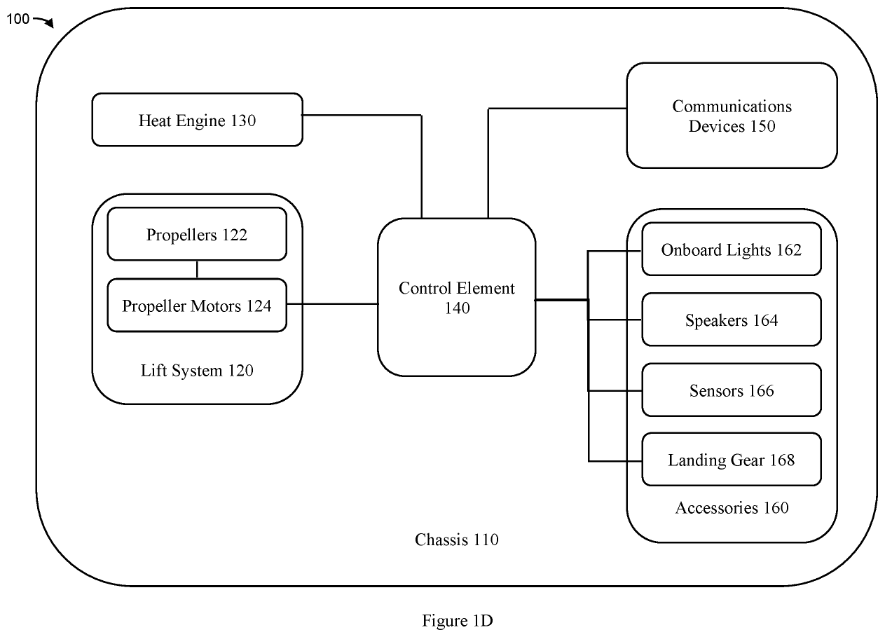

FIGS. 1A, 1B, 1C, and 1D show an example of a drone 100. FIG. 1A shows a front view of the drone 100. FIG. 1B shows a side view of the drone 100. FIG. 1C shows a top view of the drone 100. FIG. 1D illustrates a block diagram of the drone 100. As illustrated, in certain embodiments, the drone 100 may have a chassis 110, a lift system 120, a heat engine 130, and one or more control elements 140. In certain embodiments, the drone 100 may comprise one or more communications devices 150 and accessories 160.

The chassis 110 may be provided such that the drone 100 is configured in a single-rotor design, multi-rotor design, fixed-wing design, hybrid fixed-wing/vertical-take-off-and-landing (VTOL) design, or the like. As illustrated, the chassis 110 of the drone 100 provides a multi-rotor design. The chassis 110 may be made of any lightweight material capable of supporting the weight of the elements of the drone 100. For example, the chassis 110 may be made of carbon fiber, titanium, aluminum, or any combination thereof. Advantageously, in some examples, the chassis 110 may be designed to be 3D printed, thus lowering the manufacturing cost.

Further, the drone 100 includes the lift system 120. The lift system 120 may include any number of propellers 122 configured to generate lift. As illustrated, the multi-rotor design of the chassis 110 provides for four lift-generating propellers 122. However, it should be appreciated that any number of propellers 122 may be used. Commonly, multi-rotor drones may include four propellers 122 (a quadcopter) or eight propellers 122 (an octocopter). The propellers 122 may be driven by one or more propeller motors 124. In certain embodiments, the one or more propeller motors 124 are electric.

The drone 100 also includes the heat engine 130. The heat engine 130 may be any type of engine that produces mechanical movement. For instance, the heat engine 130 may be an internal combustion engine (ICE). In certain embodiments, the heat engine 130 is powered by gasoline or diesel. Alternatively, the heat engine 130 may be a hydrogen engine. In some examples, the mechanical movement provided by the heat engine 130 may directly or indirectly drive the propellers 122. In some examples, the mechanical movement provided by the heat engine 130 may be output to a power system, such as the hybrid power system 200 described below.

The drone 100 may also include the one or more control elements 140. In certain embodiments, the one or more control elements 140 can be a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. In particular, the control elements 140 may be configured to autonomously control the flight of the drone 100 and/or allow for manual control of the drone 100. The one or more control elements 140 may include a memory that stores instructions executable by the one or more control elements 140. When the instructions stored in memory are executed by the one or more control elements 140, the one or more control elements 140 can implement at least a portion of a control algorithm that controls, in certain embodiments, the speed of the propellers 122. The one or more control elements 140 can be a microprocessor, but in the alternative, the one or more control elements 140 can be a controller, microcontroller, or state machine, combinations of the same, or the like. The one or more control elements 140 can include electrical circuitry configured to process computer-executable instructions. In another embodiment, the one or more control elements 140 includes an FPGA or other programmable device that performs logic operations without processing computer-executable instructions. The one or more control elements 140 can also be implemented as a combination of computing devices; for example, a combination of a DSP and a microprocessor, a plurality of microprocessors, one or more microprocessors in conjunction with a DSP core, or any other such configuration. Although described herein primarily with respect to digital technology, the one or more control elements 140 may also include primarily analog components.

In certain embodiments, the drone 100 may also include the one or more communications devices 150. The communications devices 150 may include a transmitter, receiver, or combination transceiver. One or more of the communications devices 150 may be configured to communicate with a remote computer system configured to operate the drone 100. For example, the remote computer system may be a drone remote controller, computer, laptop, smartphone, smart watch, remote server, or similar device. In some examples, the remote computer system may allow a user to manually operate the drone 100. Alternatively, or in addition, the remote computer system may be configured to autonomously operate and pilot the drone 100. In other implementations, the drone 100 can be configured to operate based on a combination of autonomous and manual control signals. For example, the drone 100 can be configured for manual control, whereby the pilot determines direction and speed of movement, while the one or more control elements 140 are configured to autonomously control the stability of the drone 100 by individually adjusting speed of one or more propeller motors 124, thereby simplifying the manual control of the drone 100.

The communications devices 150 may be configured to communicate with the remote computer system over a wide area network. The wide area network may include a wireless connection between the communications devices 150 and the remote computer system. For example, one or more of the communications devices 150 may be configured to communicate with the remote computer system over 5G, 4GLTE, 4G, Wi-Fi, Bluetooth, or the like. The communications devices 150 may be configured to receive a location signal (e.g. a GPS signal). In some examples, data collected from the drone 100, in particular from one or more sensors 166 described below, may be transmitted to the remote computer system.

The drone 100 may also comprise the one or more accessories 160. The accessories 160 may include one or more lights 162, speakers 164, sensors 166, landing gear 168, and other accessories useful for operation of the drone 100. For example, the one or more lights 162 may be configured to allow the drone 100 to operate at night or in low-visibility conditions. The one or more speakers 164 may be configured to provide an audible warning when the drone 100 is about to launch, detects an obstacle, is low on fuel or power, etc. The one or more sensors 166 may vary depending on the intended use of the drone 100 and may include obstacle avoidance sensors, cameras, antennas, etc. The landing gear 168 may be configured to allow the drone 100 to rest on the ground and may be configured to automatically deploy at a certain distance from the ground.

### Hybrid Power System

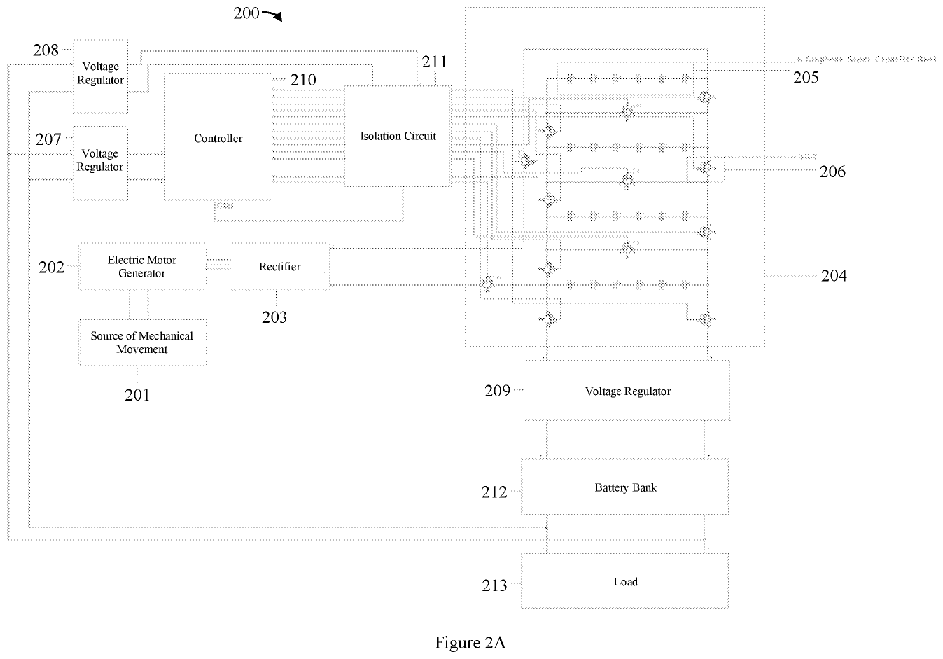

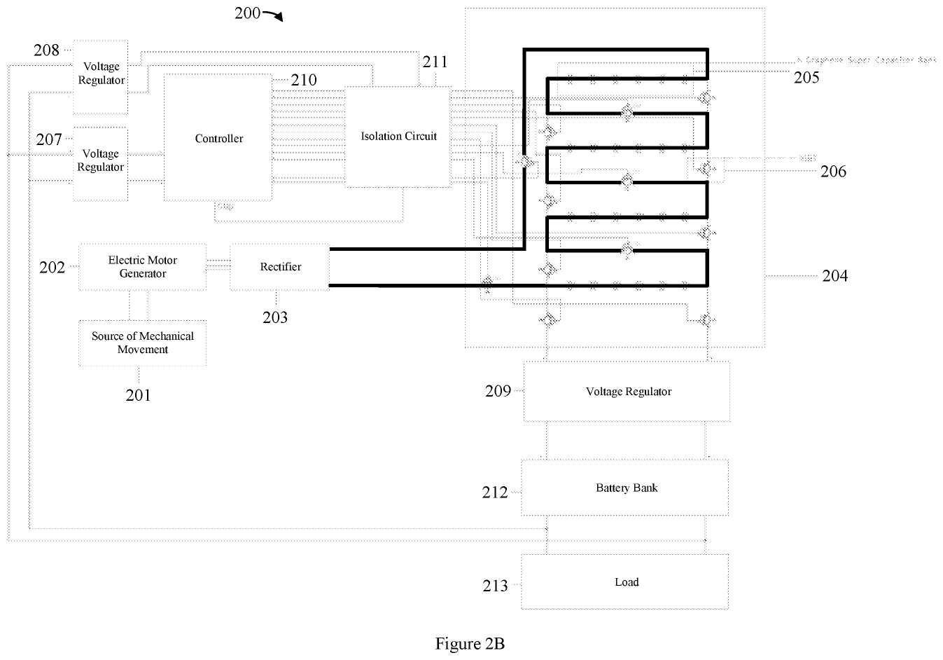

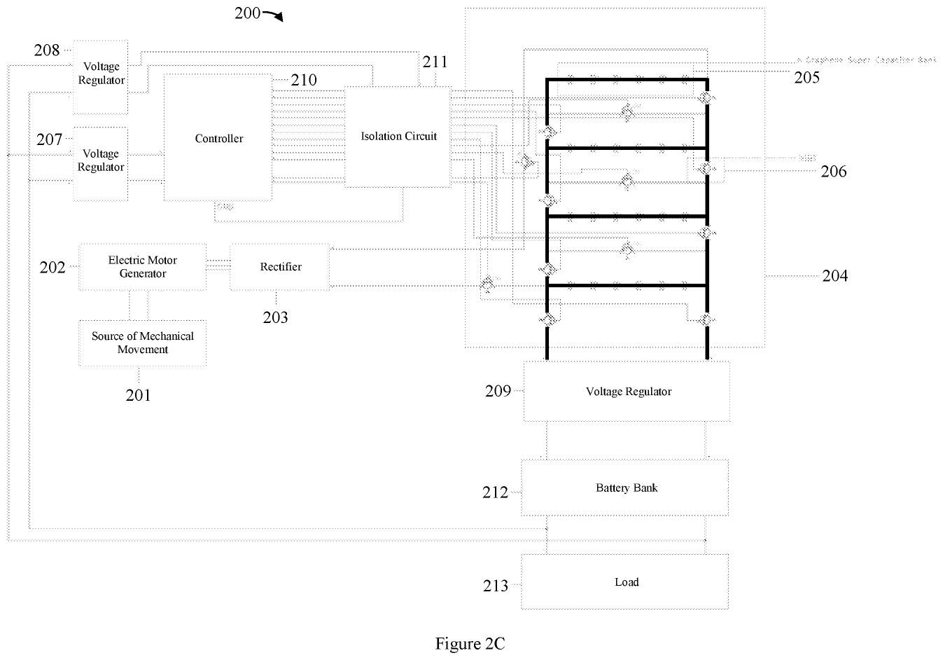

FIG. 2 illustrates a circuit diagram of a hybrid power system 200. As disclosed herein, the power system 200 may be configured to operate with the drone 100 or may be used to supplement any heat-producing power source with electrical power. In certain embodiments, the hybrid power system 200 includes a source of mechanical movement 201 and an electric motor generator 202, and a switching circuit 204. In certain embodiments, the switching circuit 204 comprises one or more graphene supercapacitor banks 205 connected by one or more transistors 206.

In some embodiments, the source of mechanical movement 201 can be implemented as a heat engine. The heat engine may be any device or system that provides mechanical movement. Other example sources of mechanical movement 201 include a wind turbine, a hydraulic turbine, gas-powered, diesel, natural gas, hydrogen, jet A1, etc.

For example, the source of mechanical movement may be an ICE configured with a drive shaft. One of the advantages of a hybrid power system 200 is that such a system may help reduce the amount of polluting gasses (e.g., carbon monoxide) emitted by an ICE by offsetting some of the power requirements to an electric motor generator 202. Advantageously, when the source of mechanical movement 201 is a hydrogen combustion engine, no emissions of polluting gasses are released from the hybrid power system 200. In at least one example, the source of mechanical movement 201 is the heat engine 130 of the drone 100.

Additionally, while the hybrid power system 200 disclosed herein may be described with reference to the drone 100, it should be appreciated that such a system may be advantageously implemented in other scenarios as well. For instance, the disclosed hybrid power system 200 may be employed in a power station. In some examples, the rotational motion of a wind turbine may serve as the source of mechanical movement 201. Alternatively, a hydraulic turbine of a hydroelectric power station may be the source of mechanical movement 201.

The electric motor generator 202 may be any device capable of transforming heat into electricity. For example, the electric motor generator 202 may be a permanent magnet brushless motor, an internal permanent magnet motor, a 3-phase AC induction copper rotor motor, a permanent magnet brushless axial flux motor, a synchronous reluctance generator, or any type of alternator.

In certain embodiments, the electric motor generator 202 can be configured to receive mechanical movement from the source of mechanical movement 201. For example, the electric motor generator 202 may be configured to receive the drive shaft of an ICE. In at least one example, the electric motor generator 202 is configured to receive mechanical movement from the heat engine 130 of the drone 100.

Alternatively, when the hybrid power system 200 is implemented in a power station, the electric motor generator 202 may be configured to receive mechanical movement associated with the power station's operation. For instance, the generator may be configured to receive the rotational motion of a wind turbine or the movement of a hydraulic turbine.

In certain embodiments, the hybrid power system 200 comprises a rectifier 203. The rectifier 203 is an electrical device configured to convert alternating current (AC) to direct current (DC). In some embodiments, the rectifier 203 comprises a diode bridge rectifier to convert AC produced by the electric motor generator 202 to DC for use by the remainder of the switching circuit 204.

In at least some examples, the rectifier 203 is a 3-phase ideal diode bridge rectifier. A 3-phase rectifier uses six diodes, which drop voltage and dissipate power at a relatively low current. This may lead to high energy losses and a more intricate thermal design. In contrast, a 3-phase ideal diode bridge rectifier replaces the six diodes with three ideal diode bridge controllers, driving six low-loss N-channel MOSFETs. Therefore, the 3-phase ideal diode bridge rectifier may result in less overall energy loss and simpler thermal design requirements than other designs, thereby providing a significant advantage over other designs.

As described above, the switching circuit 204 includes the one or more graphene supercapacitor banks 205. In certain embodiments, the one or more graphene supercapacitor banks 205 are connected by the one or more transistors 206. In some embodiments, the transistors 206 may be implemented as insulated gate bipolar transistors (IBGTs); however, aspects of this disclosure are not limited thereto.

The graphene supercapacitor banks 205 may include one or more graphene supercapacitors. The number of graphene supercapacitors may be the same in each graphene supercapacitor bank 205 of the switching circuit 204. However, in other embodiments, the number of graphene superconductors may vary between two or more of the graphene supercapacitor banks 205. The capacitance of the graphene supercapacitors may be relatively large. For example, individual graphene supercapacitors in a graphene supercapacitor bank 205 may have capacitance ranging from 1F to 5000F. Within each graphene supercapacitor bank 205, the individual graphene supercapacitors may be connected in series. The overall voltage of the graphene supercapacitor banks 205 included in the switching circuit 204 may be dependent on the voltages for the individual graphene supercapacitors of each graphene supercapacitor bank 205. In some examples, individual graphene supercapacitors may have a voltage of 2.7V. However, other voltages for the individual graphene supercapacitors are also possible.

Further, the switching circuit 204 is configured to selectively connect the graphene supercapacitor banks 205 in series or in parallel by controlling the state of the transistors 206. In particular, as illustrated in FIG. 2B, the switching circuit 204 may be configured to connect the graphene supercapacitor banks 205 in series when charging the graphene supercapacitor banks 205 via the rectifier 203. By connecting the graphene supercapacitor banks 205 in series when connected to the rectifier 203, a relatively high voltage is achieved across the graphene supercapacitor banks 205, which may facilitate charging. Thus, the connection of the graphene supercapacitor banks 205 in series, while connecting the graphene supercapacitor banks 205 to the rectifier 203, may be considered a “charging circuit” or “charging state.”

In certain embodiments, the hybrid power system 200 comprises one or more voltage regulators 207, 208, 209 and a load 213. As illustrated in FIG. 2C, the switching circuit 204 may be configured to connect the graphene supercapacitor banks 205 in parallel to discharge the graphene supercapacitor banks 205 into the voltage regulator 209 described below. This method may be use, for example, when providing power to the load 213. By connecting the graphene supercapacitor banks 205 in parallel, the graphene supercapacitor banks 205 may remain at a relatively lower voltage while discharging the graphene supercapacitor banks 205. The parallel circuit, including the graphene supercapacitor banks 205, may, therefore, be considered a “discharge circuit” or “discharging state.”

As described above, the switching circuit 204 may be configured to switch the graphene supercapacitor banks 205 between the charging state and discharging state using the one or more transistors 206. The switching circuit 204 may be configured to receive one or more control signals from the controller 210 and switch between the charging and discharging states. For example, as described above, the graphene supercapacitor banks 205 may be connected through one or more IGBTs. An IGBT is an electronic switch configured to rapidly change from a first state to a second state. Therefore, while the graphene supercapacitor banks 205 are in the charging state, the switching IGBTs may be set to a first state that places the graphene supercapacitor banks 205 in the series state. The IGBTs 206 may then change states to a second state that places the graphene supercapacitor banks 205 in the parallel discharge state. Further, the state of the IGBTs 206 may be controlled by the controller 210.

Together, the elements of the switching circuit 204 allow the hybrid power system 200 to be highly efficient compared to drones that use a single power source. When the graphene supercapacitor banks 205 are connected in series, the graphene supercapacitor banks 205 can be charged with a relatively high voltage, which can be advantageous for quickly storing the energy from the generator 202 in the individual graphene supercapacitors. Further, the high capacitance of the individual graphene supercapacitors forming the graphene supercapacitor banks 205 allows the hybrid power system 200 to store more energy and reduce wasted energy. When the graphene supercapacitor banks 205 are connected in parallel, they output a relatively low voltage to the load 213, which is advantageous for outputting to the voltage regulator 209 described below since the electric propeller motors 124 may be optimized to operate at a lower voltage than the ideal charging voltage for the graphene supercapacitors. By rapidly switching between the charging state and the discharging state, the graphene supercapacitor banks 205 are able to both (i) quickly capture energy generated, and (ii) discharge energy over longer periods of time, as needed.

In certain embodiments, the hybrid power system 200 comprises a controller 210, an isolation circuit 211, and a battery bank 212. The one or more voltage regulators 207, 208, 209 may be designed to maintain a constant voltage output, regardless of the input voltage. For example, as illustrated, the one or more voltage regulators 207, 208, 209 can be configured to provide a constant voltage to one or more of the controllers 210, the isolation circuit 211, and the battery bank 212. In some examples, the one or more voltage regulators 207, 208, 209 may be a DC/DC boost converter. A boost converter is also known as a “step-up converter” because it increases the input voltage to a higher output voltage. Alternatively, in some examples, the one or more voltage regulators 207, 208, 209 may be a DC/DC step-down converter. A “step-down converter” decreases the input voltage from a higher input voltage to a lower output voltage. Alternatively, in other examples, the one or more voltage regulators 207, 208, 209 may be a DC/DC step-up/step-down converter capable of switching between the functions of a step-up converter and a step-down converter.

Depending on the embodiment, the controller 210 may include one or more of a processing unit (or “processor”), a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. In particular, the controller 210 may be configured to set the state of the one or more transistors 206 and thereby control the state of the switching circuit 204. The controller 210 may include a memory that stores instructions executable by the controller 210. When the instructions stored in memory are executed by the controller 210, the controller 210 can implement at least a portion of a control algorithm that switches the one or more transistors 206 between the first state and the second state, thus switching the graphene supercapacitor banks 205 between the charging state and the discharging state. The controller 210 can be a microprocessor or, in the alternative, the controller 210 can be a processor, microcontroller, state machine, combinations of the same, or the like. The controller 210 can include electrical circuitry configured to process computer-executable instructions. In another embodiment, the controller 210 includes an FPGA or other programmable device that performs logic operations without processing computer-executable instructions. The controller 210 can also be implemented as a combination of computing devices; for example, a combination of a DSP and a microprocessor, a plurality of microprocessors, one or more microprocessors in conjunction with a DSP core, or any other such configuration. Although described herein primarily with respect to digital technology, the controller 210 may also include primarily analog components.

Further, the hybrid power system 200 may include the isolation circuit 211. In some implementations, the isolation circuit 211 may be implemented as an optocoupler isolation module 211, which is configured to transfer an electrical signal between two isolated circuits by using light. Advantageously, this prevents high voltage inputs from affecting the output circuit. As illustrated, the optocoupler isolation module 211 receives one or more inputs from the controller 210 and passes the electrical signal to one or more outputs coupled to the one or more transistors 206.

The battery bank 212 can include any number of batteries or battery cells. The individual batteries or battery cells of the battery bank 212 may be identical or different depending on the implementation. The batteries or battery cells may be configured in series, parallel, or any combination of series and parallel circuits, as needed to produce a desired output voltage. As illustrated, the battery bank 212 may be configured to receive and store the output of the graphene supercapacitor banks 205 through the one or more voltage regulator 209. The battery bank 212 may be of any capacity.

As described herein, the hybrid power system 200 is configured to output electrical energy to the electrical load 213. The electrical load 213 may be any output that consumes power. For example, when the drone 100 is configured with the hybrid power system 200, the electrical load 213 may be the propeller motors 124 of the lift system 120, the control element 140, the communications devices 150, the accessories 160, and the like. In other instances, when the hybrid power system 200 is employed in a power station, the electrical load may be the electricity grid powered by the power station.

### Terminology

It should be understood that not all objects or advantages may necessarily be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages taught or suggested herein.

Conditional language such as, “can,” “could,” “might” or “may,” among others, unless specifically stated otherwise, are understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or performed in any particular embodiment.

Disjunctive language such as the phrase “at least one of X, Y, or Z,” unless specifically stated otherwise, is understood within the context as used in general to represent that an item, term, etc., may be either X, Y, or Z, or any combination thereof (for example, X, Y, and/or Z). Thus, such disjunctive language is not generally intended to imply that certain embodiments require at least one of X, at least one of Y, or at least one of Z to each be present.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

While the above-detailed description may have shown, described, and pointed out novel features as applied to various embodiments, it may be understood that various omissions, substitutions, and/or changes in the form and details of any particular embodiment may be made without departing from the spirit of the disclosure. As may be recognized, certain embodiments may be embodied within a form that does not provide all of the features and benefits set forth herein, as some features may be used or practiced separately from others.

Additionally, features described in connection with one embodiment can be incorporated into another of the disclosed embodiments, even if not expressly discussed herein, and embodiments having the combination of features still fall within the scope of the disclosure. For example, features described above in connection with one embodiment can be used with a different embodiment described herein, with the combination still falling within the scope of the disclosure.

It should be understood that various features and aspects of the disclosed embodiments can be combined with, or substituted for, one another in order to form varying modes of the embodiments of the disclosure. Thus, it is intended that the scope of the disclosure herein should not be limited by the particular embodiments described above. Accordingly, unless otherwise stated, or unless clearly incompatible, each embodiment of this disclosure may comprise, additional to its essential features described herein, one or more features as described herein from each other embodiment disclosed herein.

Features, materials, characteristics, or groups described in conjunction with a particular aspect, embodiment, or example are to be understood to be applicable to any other aspect, embodiment or example described in this section, or elsewhere in this specification, unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), as well as to any novel one, or any novel combination, of the steps of any method or process so disclosed.

Furthermore, certain features that are described in this disclosure in the context of separate implementations can also be implemented in combination with a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown, or in sequential order, nor that all operations be performed at all, in order to achieve the desired results. Other operations that are not depicted or described can be incorporated in the methods and processes described herein. For example, one or more additional operations can be performed before, after, simultaneously, or between any of the described operations. Further, the operations may be rearranged or reordered in other implementations. Those skilled in the art will appreciate that, in some embodiments, the actual steps taken in the processes illustrated and/or disclosed may differ from those shown in the figures. Depending on the embodiment, certain of the steps described above may be removed, while others may be added.

Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations. Also, it should be understood that the described components and systems can generally be integrated together in a single product or packaged into multiple products.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage, or a group of advantages, as taught herein without necessarily achieving other advantages taught or suggested herein.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately,” “about,” “generally,” and “substantially” may refer to an amount that is within less than 10% of, within less than 5% of, within less than 1% of, within less than 0.1% of, and within less than 0.01% of the stated amount. As another example, in certain embodiments, the terms “generally parallel” and “substantially parallel” refer to a value, amount, or characteristic that departs from exactly parallel by less than or equal to 15 degrees, 10 degrees, 5 degrees, 3 degrees, 1 degree, 0.1 degree, or otherwise.

The scope of the present disclosure is not intended to be limited by the specific disclosures of preferred embodiments in this section, or elsewhere in this specification, and may be defined by claims as presented in this section, or elsewhere in this specification, or as presented in the future. The language of the claims is to be interpreted broadly based on the language employed in the claims and not limited to the examples described in the present specification, or during the prosecution of the application, which examples are to be construed as non-exclusive.

Unless the context clearly requires otherwise, throughout the description and the claims, the words “comprise,” “comprising,” and the like, are to be construed in an inclusive sense, as opposed to an exclusive or exhaustive sense, which is to say in the sense of “including but not limited to.”

Reference to any prior art in this description is not, and should not be taken as, an acknowledgement or any form of suggestion that such prior art forms part of the common general knowledge in the field of endeavor in any country of the world.

The invention may also be said broadly to consist in the parts, elements and features referred to or indicated in the description of the application, individually or collectively, in any or all combinations of two or more of said parts, elements or features.

Where, in the foregoing description, reference has been made to integers or components having known equivalents thereof, those integers are herein incorporated as if individually set forth. In addition, where the term “substantially” or any of its variants have been used as a word of approximation adjacent to a numerical value or range, it is intended to provide sufficient flexibility in the adjacent numerical value or range that encompasses standard manufacturing tolerances and/or rounding to the next significant figure, whichever is greater.

It should be noted that various changes and modifications to the presently preferred embodiments described herein will be apparent to those skilled in the art. Such changes and modifications may be made without departing from the spirit and scope of the invention and without diminishing its attendant advantages. For instance, various components may be repositioned as desired. It is therefore intended that such changes and modifications be included within the scope of the invention. Moreover, not all of the features, aspects and advantages are necessarily required to practice the present invention. Accordingly, the scope of the present invention is intended to be defined only by the claims.

What is claimed is:

1. A drone, comprising:
one or more propellers configured to lift the drone;
a heat engine configured to generate mechanical movement;
an electric generator configured to receive the mechanical movement and generate electric power; and
one or more graphene supercapacitor banks configured to receive the electric power generated by the electric generator, each of the one or more graphene supercapacitor banks comprising a plurality of graphene supercapacitors coupled in series, wherein the one or more graphene supercapacitor banks are configured to provide power to the one or more propellers.

2. The drone of claim 1, further comprising a 3-phase ideal diode bridge rectifier, wherein the 3-phase ideal diode bridge rectifier is configured to rectify an alternating current received from the electric generator into a direct current provided to the one or more graphene supercapacitor banks.

3. The drone of claim 2, wherein the one or more graphene supercapacitor banks are connected in series to the 3-phase ideal diode bridge rectifier, forming a charging state.

4. The drone of claim 1, further comprising:
a battery bank configured to power the one or more propellers; and
one or more transistors configured to selectively connect the one or more graphene supercapacitor banks in parallel to provide power to the one or more propellers in a discharge state.

5. The drone of claim 1, further comprising:
one or more transistors configured to alternately connect the one or more graphene supercapacitor banks in series and in parallel; and
a controller configured to control the one or more transistors.

6. The drone of claim 5, wherein the one or more transistors comprise one or more insulated gate bipolar transistors.

7. The drone of claim 1, wherein each of the plurality of graphene supercapacitors has a voltage of about 2.7 V and a capacitance of 1 F to 5000 F.

8. A hybrid power system, comprising:
a source of mechanical movement;
an electric generator configured to receive mechanical movement from the source of mechanical movement and generate electric power;
a rectifier;
one or more graphene supercapacitor banks configured to receive the electric power generated by the electric generator, each of the one or more graphene supercapacitor banks comprising a plurality of graphene supercapacitors coupled in series;
a battery bank;
a charging circuit comprising the rectifier and the one or more graphene supercapacitor banks; and
a discharge circuit comprising the battery bank and the one or more graphene supercapacitor banks.

9. The hybrid power system of claim 8, wherein the source of mechanical movement is an internal combustion engine.

10. The hybrid power system of claim 9, wherein the internal combustion engine is a hydrogen engine.

11. The hybrid power system of claim 8, wherein the source of mechanical movement is a wind turbine or a hydraulic turbine.

12. The hybrid power system of claim 8, wherein the electric generator is a permanent magnet brushless motor, an internal permanent magnet motor, a three phase AC induction copper rotor motor, a permanent magnet brushless axial flux motor, a synchronous reluctance generator, or an alternator.

13. The hybrid power system of claim 8, wherein the rectifier is a 3-phase ideal diode bridge rectifier.

14. The hybrid power system of claim 8, further comprising:
one or more transistors configured to alternately connect the one or more graphene supercapacitor banks to the charging circuit and to the discharge circuit; and
a controller configured to control the one or more transistors.

15. The hybrid power system of claim 14, wherein the charging circuit is a series circuit, and the discharge circuit is a parallel circuit.

16. The hybrid power system of claim 14, wherein the controller is a field programmable gate array.

17. A graphene supercapacitor bank system comprising:
one or more graphene supercapacitors banks configured to receive a direct current supply, each of the one or more graphene supercapacitor banks comprising a plurality of graphene supercapacitors coupled in series;
a battery bank; and
a plurality of transistors controlled by a controller; wherein:
the one or more graphene supercapacitor banks are coupled in a series circuit with the direct current supply by the plurality of transistors; and
the one or more graphene supercapacitor banks are coupled in a parallel circuit with the battery bank by the plurality of transistors.

18. The graphene supercapacitor bank system of claim 17, wherein the plurality of graphene supercapacitors have a capacitance of at least 1 F and at most 5000 F.

19. The graphene supercapacitor bank system of claim 17, wherein the plurality of graphene supercapacitors have a voltage of 2.7V.

20. The graphene supercapacitor bank system of claim 17, wherein the controller is configured to alternatively place the one or more graphene supercapacitor banks in the series circuit and in the parallel circuit.

21. The graphene supercapacitor bank system of claim 17, wherein the controller is a field programmable gate array.
